(19) United States
(12) Patent Application Publication
(10) Pub. No.: US 2013/0242615 A1
(43) Pub. Date: Sep. 19, 2013

(54) Water-Proof Light-Emitting Decoration Building Block

(71) Applicant: Chia-Yen Lin, Dongguan City (CN)

(72) Inventor: Chia-Yen Lin, Dongguan City (CN)

(21) Appl. No.: 13/420,795

(22) Filed: Mar. 15, 2012

(51) Int. Cl. H01R 33/00

(52) U.S. Cl. 362/640

(57) ABSTRACT

A water-proof light-emitting decoration building block is connected to the top or bottom end of connected conventional light-emitting basic interlocking bricks and includes a light-transmittable brick, multiple first one-way conductive members and multiple second one-way conductive members. The brick has a top end and a bottom end, one of the top and bottom ends has a water-proof decoration portion and the other end has multiple connection portions. Each of the first one-way conductive members has a conductive rod. The conductive rods of the first one-way conductive members and the second one-way conductive members are respectively located in the connection portions. The water-proof light-emitting decoration building blocks can be connected to the top or bottom end of assembled basic light-emitting interlocking bricks to obtain water-proof and light-emitting features.

### BACKGROUND OF THE INVENTION

1. Field of the Invention

The present invention relates generally to a light-emitting building block, and in particular to a water-proof light-emitting building block that are assembled to the a top end or a bottom end of light-emitting building block, so as to prevent first and second two-way conductive members from being exposed to the exterior environment and prevent water from entering the interior of the assembled building blocks.

2. The Prior Arts

Building blocks are a popular toy which allows players to construct anything, ranging from robot to airplane. Not only Children of all ages enjoy playing daily, but also playing the building blocks can improve hand-eye coordination of young children.

Generally, the conventional building blocks are classified into two categories: basic interlocking bricks and accompanying decoration bricks, such as gears and minifigures. The player can fit together the basic interlocking bricks to construct anything, such as buildings and vehicles. The decoration bricks are used to decorate the forms or shapes of the assembled basic interlocking bricks to provide an attractive appearance. For example, the decoration brick can provide a driver figure to a bus made by the basic interlocking bricks. Referring to FIG. 8, a conventional light-emitting building block comprises a light transmittable basic interlocking brick 70, a plurality of first two-way conductive members 80 and a plurality of second two-way conductive members 90. The basic interlocking brick 70 includes a circuit board 71 disposed therein and a plurality of connection portions 72 disposed on a top end and a bottom end thereof The circuit board 71 has a light 74 and a plurality of through holes 711. Each of the through holes 711 is defined between the connection portion 72 of the top end and the connection portion 72 of the bottom end.

Each of the first two-way conductive members 80 has a sleeve 81, two conductive rods 82 and a spring 83. The sleeve 81 respectively defines a through holes 811 in the top and bottom thereof The bottom of the sleeves 81 are inserted into the through holes 711 of the circuit board 71 and located corresponding to the connection portions 72 at the bottom of the brick 70. The top of the sleeves 81 is located corresponding to the connection portions 72 of the top end of the brick 70. The two conductive rods 82 are respectively located at the top and bottom of the sleeve 81 and protrude out of the sleeve 81. The spring 83 is disposed between the two conductive rods 82. The spring 83 is connected with a wire (not shown) which extends through the sleeve 81 and is connected with the circuit board 71.

Each of the second two-way conductive members 90 is mounted to outside of the sleeve 80 and has a wire 91 at the bottom thereof The wire 91 extends through the circuit board 71 and then forms a bent portion 92 corresponding to the edge of the connection portion 72. Then a free end of the bent portion 92 is connected with the circuit board 71.

Generally, the connection portions 72 at the top end of the brick 70 are studs and the connection portions 72 at the bottom end of the brick 70 are tubes, or vice versa.

As shown in FIG. 8, when multiple light-emitting basic interlocking bricks 70 are assembled, the connection portions 72 on the top end of one brick 70 (the lower brick) are connected with the connection portions 72 at the bottom end of another brick 70 (the upper brick). The conductive rods 82 in the connection portions 72 at the top end of one brick 70 (the lower brick) are in contact with the conductive rods 82 in the connection portions 72 at the bottom end of another brick 70 (the lower brick). The second two-way conductive member 90 of one brick 70 (the lower brick) is in contact with the bent portion 92 of the wire 91 of another brick 70 (the upper brick) to electrically connect the multiple bricks 70.

Because the player can assemble as many basic interlocking bricks 70 as he wishes, the first and second two-way conductive members 80, 90 have to be exposed to the exterior so that the circuits of the unlimited bricks 70 can be electrically connected together. However, if the bricks 70 are played at outdoors or on a wet surface and the first and second two-way conductive members 80, 90 of the bricks 70 are damped by water, a short circuit would occur. Thus, it is necessary to develop a water-proof light-emitting building block to prevent the occurrence of short circuit.

### SUMMARY OF THE INVENTION

A primary objective of the present invention is to provide a water-proof light-emitting decoration building block that overcomes the disadvantages of conventional designs which can not prevent water from entering the interior of the connected building blocks.

In order to achieve the objective, a water-proof light-emitting decoration building block according to the present invention comprises a light-transmittable brick having a top end and a bottom end. One of the top and bottom ends has a water-proof decoration portion, and the other end has a plurality of connection portions. A circuit board is located in the brick and a light is connected to the circuit board. A plurality of insertion holes are defined in the circuit board and located corresponding to the connection portions.

A plurality of first one-way conductive members are respectively connected to the circuit board and each of the first one-way conductive members has a sleeve, a conductive rod and a spring. The sleeve is inserted into the insertion hole and extends into the connection portion of the brick. The conductive rod is received in the sleeve and extends through a through hole of the sleeve. The spring is located in the sleeve and biased between an inside of the sleeve and the conductive rod. The spring has a wire connected thereto and the wire is connected to the circuit board.

A plurality of second one-way conductive members are respectively located in the connection portions of the brick and connected with the circuit board.

The water-proof light-emitting decoration building blocks according to the present invention can be connected to the top or bottom ends of assembled light-emitting basic interlocking bricks. Therefore, the water-proof light-emitting decoration building blocks provide water-proof feature. The water-proof decoration portion can be in any shape to provide decoration feature. The first and second one-way conductive members of the water-proof light-emitting decoration building blocks are respectively connected to the first and second two-way conductive members of the basic interlocking bricks. Thus, the water-proof light-emitting decoration building blocks provide light-emitting feature.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective bottom view showing a water-proof light-emitting decoration building block in accordance with a first embodiment of the present invention;

FIG. 2 is a cross-sectional view taken along line II-II of FIG. 1;

FIG. 3 is a cross-sectional view taken along line III-III of FIG. 1;

FIG. 4 is a perspective top view showing a water-proof light-emitting decoration building block in accordance with a second embodiment of the present invention;

FIG. 5 is a cross-sectional view taken along line V-V of FIG. 4;

FIG. 6 is a cross-sectional view taken along line VI-VI of FIG. 4;

FIG. 7 is a cross-sectional view to show that the water-proof light-emitting decoration building blocks in accordance with the present invention are connected with a conventional light-emitting basic interlocking brick; and

FIG. 8 is a cross-sectional view to show the connected conventional light-emitting basic interlocking bricks.

### DETAILED DESCRIPTION OF THE PREFERRED EMBODIMENT

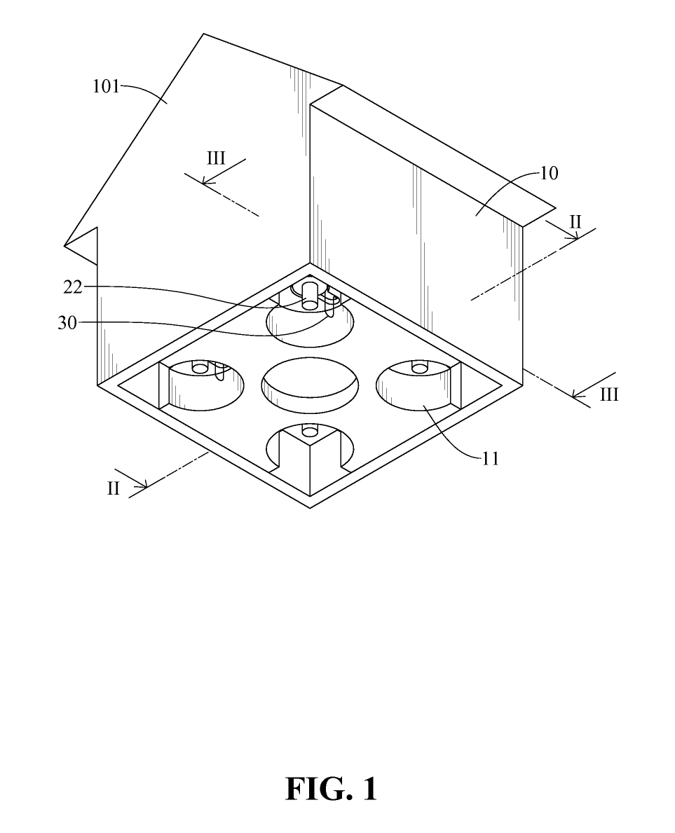

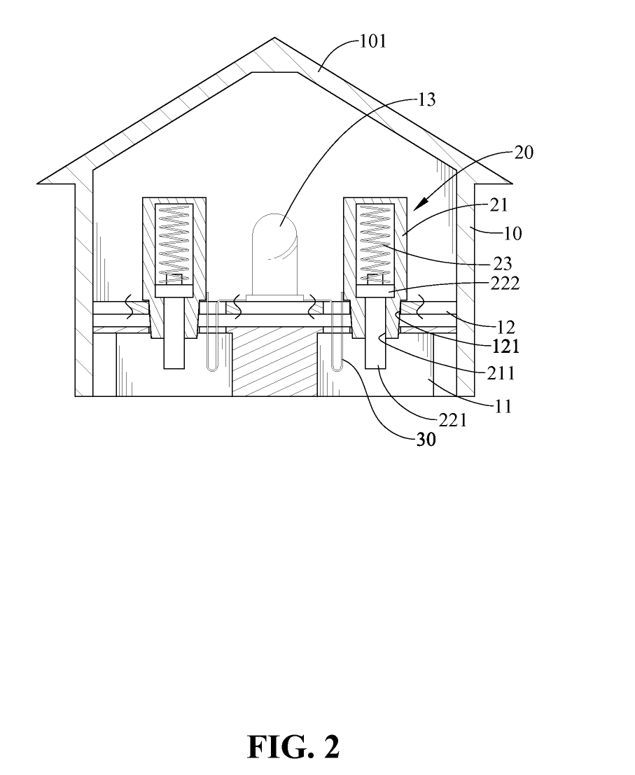

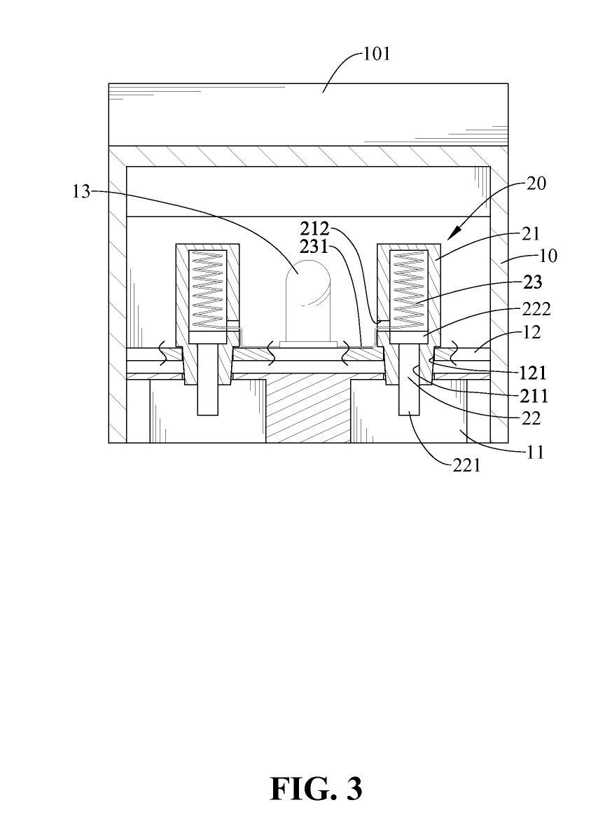

With reference to FIGS. 1, 2 and 3, a water-proof light-emitting decoration building block in accordance with a first embodiment of the present invention comprises a light-transmittable brick 10, a plurality of first one-way conductive members 20 and a plurality of second one-way conductive members 30. The brick 10 has a top end and a bottom end opposite to the top end. The brick 10 includes a water-proof decoration portion 101 disposed at the top end thereof, a plurality of connection portions 11 disposed at the bottom end thereof and a circuit board 12 disposed therein. A light 13 is connected to the circuit board 12, and a plurality of insertion holes 121 are defined in the circuit board 12 and located corresponding to the connection portions 11. The water-proof decoration portion 101 can be in any shape and may be integrally formed with the brick 10. According to the first embodiment, the connection portions 11 are tubes and the water-proof decoration portion 101 is shaped as a house roof Therefore, when assembling the building blocks to construct a house or a castle, the decoration portion 101 can serve as a roof.

The first one-way conductive members 20 are connected to the circuit board 12 and each of the first one-way conductive members 20 has a sleeve 21, a conductive rod 22 and a spring 23. The sleeve 21 has a through hole 211 defined in a bottom thereof The bottom of the sleeve 21 is inserted through the insertion hole 121 of the circuit board 12 and projected into the connection portion 11 of the brick 10. The conductive rod 22 is received in the bottom of the sleeve 21 and extended out of the sleeve 21. The spring 23 is axially disposed in the sleeve 21 and biased between an inside of the sleeve 21 and the conductive rod 22. The spring 23 has a wire 231 connected thereto. The sleeve 21 has a side hole 212 defined in a wall thereof The wire 231 extends through the side hole 212 of the sleeve 21 and connects with the circuit board 12. The conductive rod 22 has a wide portion 222 received in the sleeve 21 and a narrow portion 221 passing through the through hole 211 of the sleeve 21 and extending out of the sleeve 21.

The second one-way conductive members 30 are fixed to the circuit board 12. The second one-way conductive members 30 are respectively disposed in the connection portions 11 of the brick 10 and electrically connected with the circuit board 12. The second one-way conductive member 30 according to the first embodiment is a U-shaped metal wire.

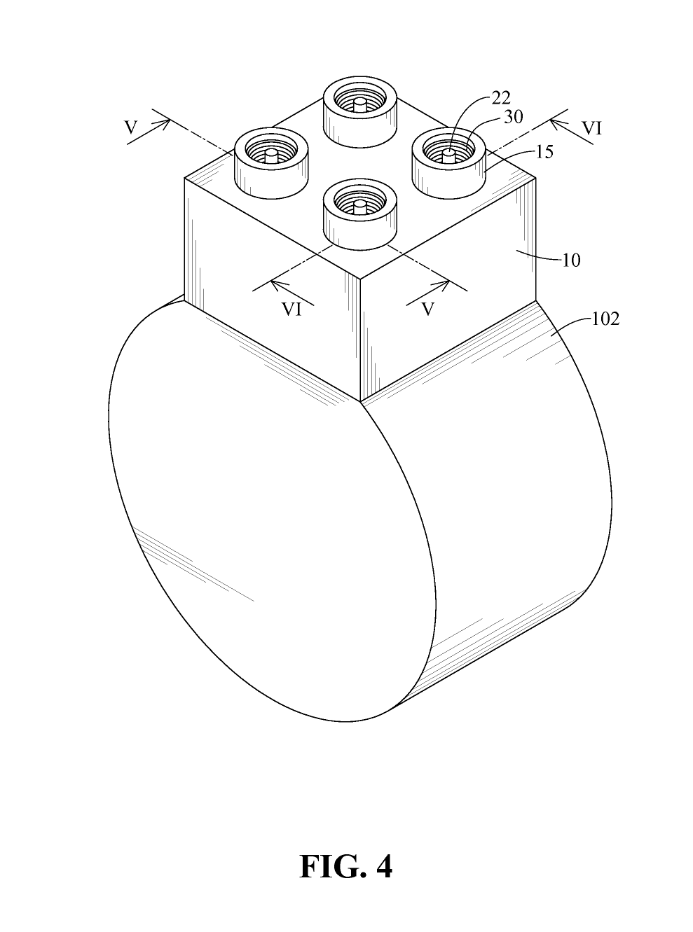

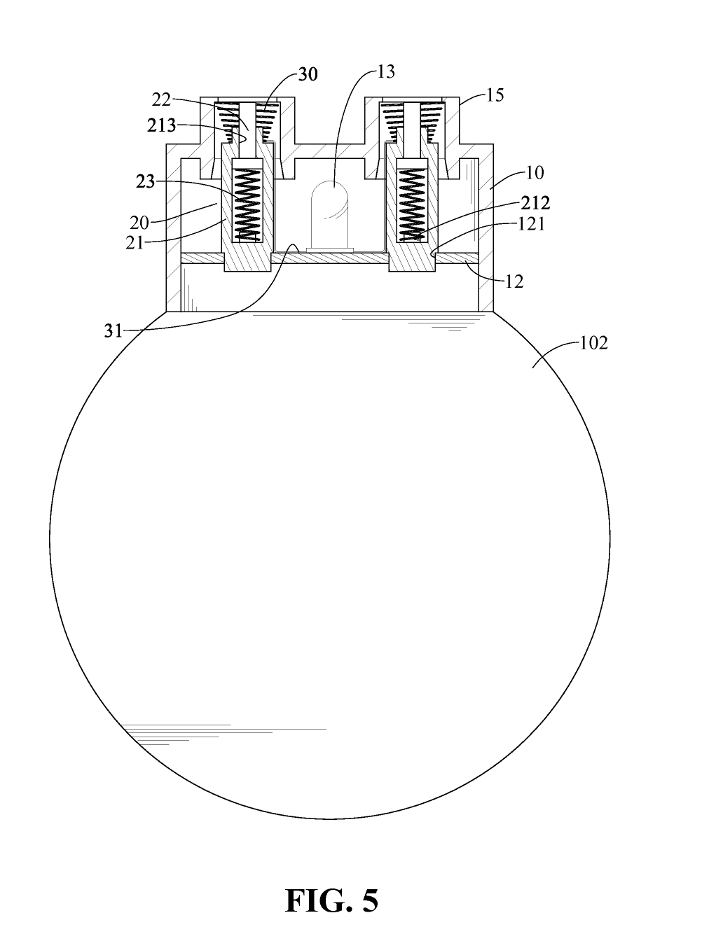

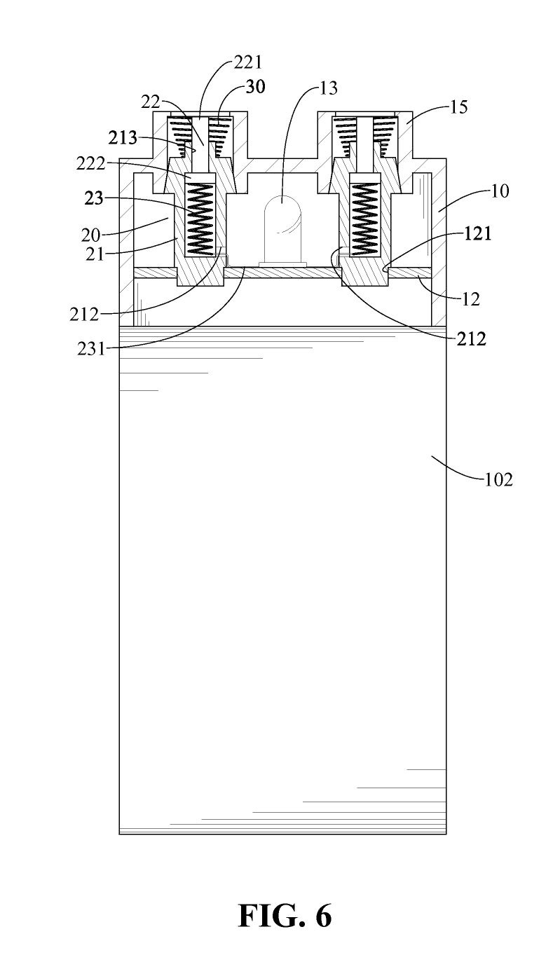

Referring to FIGS. 4 to 6, a water-proof light-emitting decoration building block in accordance with a second embodiment of the present invention has a structure similar to that of the first embodiment. The brick 10 includes a plurality of connection portions 15 disposed at the top end thereof and a water-proof decoration portion 102 disposed at the bottom end thereof. Each of the connection portions 15 is a hollow cylinder. The insertion holes 121 of the circuit board 12 are located corresponding to the connection portions 15 of the brick 10. The water-proof decoration portion 102 is made of a non-conductive material. Moreover, the water-proof decoration portion 102 according to the second embodiment is shaped in a circular disk but the water-proof decoration portion 102 may be made into any shape. The circular disk can serve as the wheel when the building blocks are assembled to create a car. Because the water-proof decoration portions 102 is made of non-conductive water-proof material and with closed end at bottom, the water-proof decoration portions 102 can be put on wet surfaces directly.

The sleeve 21 of the first one-way conductive members 20 has a through hole 213 defined in the top thereof so that the conductive rod 22 is received in the sleeve 21 and projected out of the sleeve 21. The bottom of the sleeve 21 is inserted into the insertion hole 121 of the circuit board 12 and the top of the sleeve 21 is disposed in the connection portion 15 of the brick 10. The spring 23 is biased between the inside of the sleeve 21 and the conductive rod 22. The sleeve 21 has a side hole 212 defined in a wall thereof and the wire 231 extends through the side hole 212. Each of the conductive rods 22 has a wide portion 222 received in the sleeve 21 and a narrow portion 221 passing through the through hole 213 of the sleeve 21 and extending out of the sleeve 21.

Each of the second one-way conductive members 30 is fixed to the outside of the top of the sleeve 21 and located in the connection portion 15. The wire 31 is connected to the bottom of the second one-way conductive member 30 and electrically connected to the circuit board 12. According to the second embodiment, the second one-way conductive member 30 is a cone-shaped spring.

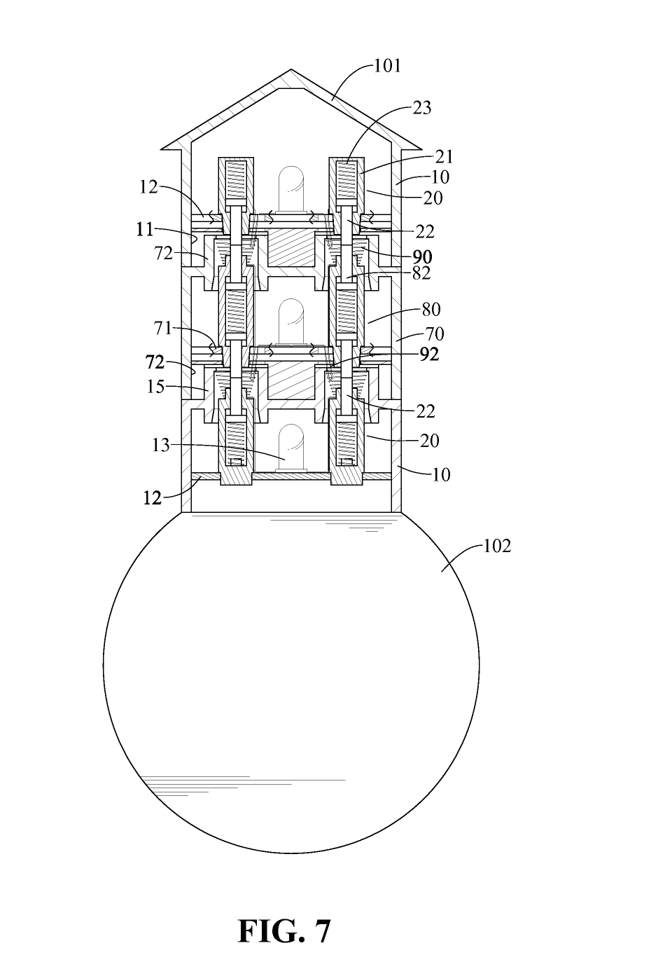

Referring to FIG. 7, the water-proof light-emitting decoration building blocks according to the first and second embodiments of the present invention are respectively connected to the top end and bottom end of a conventional light-emitting basic interlocking brick 70 that has the first and second two-way conductive members 80, 90. As shown in the upper portion of FIG. 7, when the water-proof light-emitting decoration building block according to the first embodiment connects with the basic interlocking brick 70, the connection portions 72 (studs) on the top of the basic interlocking brick 70 are inserted into the connection portions 11 (tubes) in the bottom of the brick 10. The conductive rod 82 on the top of the first two-way conductive member 80 electrically connects with the conductive rod 22 on the bottom of the first one-way conductive member 20. The second two-way conductive member 90 electrically connects with the second one-way conductive member 30. Therefore, the brick 10 according to the first embodiment of the present invention electrically connects with the basic interlocking brick 70 having the first and second two-way conductive members 80, 90. In addition to emitting light and serving as decoration, the brick 10 has the water-proof decoration portion 101 disposed at the top end to keep water from entering the interior of the connected bricks, thereby protecting the circuit from short circuit.

As shown in the lower portion of FIG. 7, the water-proof light-emitting decoration building block according to the second embodiment of the present invention is used to connect with the bottom end of the conventional basic interlocking brick 70. When assembling the brick 10 according to the second embodiment with the basic interlocking brick 70, the connection portions 15 (studs) on the top end of the brick 10 are inserted into the connection portions 72 (tubes) in the bottom of the basic interlocking brick 70. The conductive rod 22 of the first one-way conductive member 20 on the top of the brick 10 is electrically connected with the conductive rod 82 of the first two-way conductive member 80 on the bottom of the basic interlocking brick 70. The second one-way conductive member 30 of the brick 10 according to the present invention electrically connects with the bent portion 92 of the second two-way conductive member 90. Therefore, the basic light-emitting brick 70 having the first and second two-way conductive members 80, 90 electrically connects with the brick 10 according to the second embodiment of the present invention. In addition to emitting light and serving as decoration, the brick 10 has the closed-ended water-proof decoration portion 102 disposed at the bottom end to keep water from entering the interior of the connected bricks, thereby protecting the circuit from short circuit.

The water-proof light-emitting decoration building block according to the present invention provides the water-proof decoration portion 101, 102 respectively disposed at the top end and bottom end of the brick 10, and the first and second one-way conductive members 20, 30 disposed in the brick 10 to be respectively connected to the first and second two-way conductive members 80, 90 of the conventional light-emitting basic interlocking brick 70. The water-proof light-emitting decoration building blocks according to the present invention can be used to be connected to the top ends and/or the bottom ends of the connected basic interlocking bricks 70. The water-proof decoration portions 101, 102 of the brick 10 prevent water from entering the interior of the light-emitting blocks form top or bottom to protect the circuit.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A water-proof light-emitting decoration building block, comprising:
a light-transmittable brick including a top end and a bottom end, one of the top and bottom ends having a water-proof decoration portion, and the other end having a plurality of connection portions, a circuit board disposed in the brick and a light connected to the circuit board, the circuit board having a plurality of insertion holes defined therein and located corresponding to the connection portions;
a plurality of first one-way conductive members respectively connected to the circuit board, each of the first one-way conductive members having a sleeve, a conductive rod and a spring, the sleeve inserted into the insertion hole and extending into the connection portion of the brick, the conductive rod received in the sleeve, passing through a through hole of the sleeve and extending out of the sleeve, the spring disposed in the sleeve and biased between an inside of the sleeve and the conductive rod, the spring having a wire connected thereto, the wire connected to the circuit board; and
a plurality of second one-way conductive members respectively disposed in the connection portions of the brick and electrically connected with the circuit board.

2. The building block as claimed in claim 1, wherein the water-proof decoration portion is located on the top end of the brick and the connection portions are disposed at the bottom end of the brick, each of the connection portions is a tube, a bottom of the sleeve is inserted into the insertion hole and a top of the sleeve is disposed in the connection portion.

3. The building block as claimed in claim 2, wherein the water-proof decoration portion is shaped as a house roof and integrally formed with the brick.

4. The building block as claimed in claim 2, wherein each of the second one-way conductive members includes a U-shaped metal wire.

5. The building block as claimed in claim 1, wherein the water-proof decoration portion is disposed at the bottom end of the brick and the connection portions are located at the top end of the brick, each of the connection portions is a hollow cylinder.

6. The building block as claimed in claim 5, wherein the water-proof decoration portion is shaped in a circular disk.

7. The building block as claimed in claim 6, wherein each of the second one-way conductive members is a cone-shaped spring.

8. The building block as claimed in claim 1, wherein the sleeve has a side hole defined in a wall thereof and the wire extends through the side hole.

9. The building block as claimed in claim 1, wherein each of the conductive rods has a wide portion received in the sleeve and a narrow portion passing through the through hole of the sleeve and extending out of the sleeve.

10. The building block as claimed in claim 8, wherein each of the conductive rods has a wide portion received in the sleeve and a narrow portion passing through the through hole of the sleeve and extending out of the sleeve.
